(19) United States
(12) Patent Application Publication
(10) Pub. No.: US 2005/0219986 A1
(43) Pub. Date: Oct. 6, 2005

(54) Optical pickup adjusting optical disc, optical pickup adjusting device, and method

(75) Inventors: Yutaka Shimada, Tokyo (JP); Hideo Nagasaka, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SONY CORPORATION, TOKYO (JP)

(21) Appl. No.: 10/517,609

(22) PCT Filed: Jun. 27, 2003
(86) PCT No.: PCT/JP03/08229

§ 371 Date: Dec. 22, 2004

(30) Foreign Application Priority Data
Jun. 28, 2002 (JP) 2002-190900

(51) Int. Cl. G11B 7/20

(52) U.S. Cl. 369/94

(57) ABSTRACT

The present invention concerns an optical disc for adjusting an optical pickup used for adjusting a pair of optical pickups capable of recording and reproducing a double-sided type optical disc. The optical disc for adjusting the optical pickups comprises: a first signal recording part (5) that is irradiated with a laser beam from one surface side; and a second signal recording part (7) that is irradiated with the laser beam from the other surface side to record data so that a scanning direction by the laser beam is opposite to that of the first signal recording part (5).

### TECHNICAL FIELD

The present invention relates to an optical disc for adjusting an optical pickup used for adjusting the optical pickup employed for recording and reproducing an optical disc having signal recording layers on both surfaces, an adjusting device for the optical pickup and an adjusting method using the adjusting device.

This application claims a priority based on Japanese Patent Application No. 2002-190900 filed on Jun. 28, 2002, in Japan, which is referred to be applied to the this application.

### BACKGROUND ART

As an optical recording medium, a CD (Compact Disc) has been widely employed. As an optical recording medium which improves a recording density more further than the CD, a DVD (Digital Versatile Disc) has been provided. The DVD includes, for instance, a double-sided type DVD in which a plurality of recording layers on which data is recorded are provided and each surface side is irradiated with a laser beam to reproduce the data. Such a DVD has two bases with recording surfaces that are bonded to each other through an adhesive.

As a device for recording and/or reproducing the above-described double-sided type DVD, there is a device in which a pair of optical pickups respectively corresponding to the surfaces are provided and one surface and the other surface of the DVD are respectively irradiated with laser beams from the optical pickups respectively opposed to the surfaces to record or reproduce each of the surfaces of the DVD.

The pair of the optical pickups respectively include a light source for emitting a laser beam having the wavelength of 635 to 650 nm, an objective lens for converging the laser beam emitted from the light source, a photodetector for detecting a returning light beam reflected on the signal recording surface of the DVD irradiated with the laser beam, and an objective lens driving part for driving and displacing the objective lens in a focusing direction and a tracking direction.

The objective lens driving part includes a lens holder for holding the objective lens, a holder support part composed of an elastic support member for supporting the lens holder so as to be displaced in the focusing direction and the tracking direction, a focusing driving part for driving and displacing the lens holder holding the objective lens in the focusing direction, and a tracking driving part for driving and displacing the lens holder holding the objective lens in the tracking direction.

The focusing driving part includes a focusing coil and a focusing magnet to drive and displace the lens holder supported by the holder support part in the direction parallel to the direction of an optical axis of the objective lens, that is, the focusing direction in accordance with the action of electric current supplied to the focusing coil and a magnetic field generated by the focusing magnet. The tracking driving part includes a tracking coil and a tracking magnet to drive and displace the lens holder supported by the holder support part in the direction perpendicular to the optical axis of the objective lens, that is, the tracking direction in accordance with the action of electric current supplied to the tracking coil and a magnetic field generated by the tracking magnet.

In the optical pickup constructed as described above, when one surface of the DVD is reproduced, the objective lens is driven and displaced by the focusing driving part so that the laser beam emitted from the light source in one optical pickup is focused on the signal recording surface of one surface of the DVD. Further, the objective lens is driven and displaced in the tracking direction by the tracking driving part to scan one signal recording surface of the DVD and read an information signal recorded on the one signal recording surface of the DVD.

In such an optical pickup, when the other surface of the DVD is reproduced, the objective lens is driven and displaced by the focusing driving part so that the laser beam emitted from the light source of the other optical pickup is focused on the signal recording surface of the other surface of the DVD. Further, the objective lens is driven and displaced in the tracking direction by the tracking driving part to scan the other signal recording surface of the DVD and read an information signal recorded on the other signal recording surface of the DVD.

The optical pickups constructed as described above are further respectively attached to base units for attaching the optical pickups to the recording and/or reproducing device. The base unit has a base attached to a casing of the recording and/or reproducing device. This base is provided with a slide member to which the optical pickup is attached, a feed mechanism for moving the slide member to which the optical pickup is attached in the radial direction of the optical disc, and a disc rotating and driving mechanism for rotating and driving the optical disc.

Upon assembling steps, in the optical pickup, the relative position of the objective lens to the light source and the inclination of the optical axis of the objective lens are respectively adjusted. The adjustment is carried out, for instance, after each optical pickup is attached to the base unit. As compared with an adjustment carried out before the optical pickup is attached to the base unit, the relative position of the objective lens to the light source and the inclination of the optical axis of the objective lens can be adjusted without depending on the assembly accuracy of the optical pickup to the base unit.

The adjustment is carried out for the corresponding recording surface of the DVD for each optical pickup. Specifically, an adjusting optical disc for the DVD is firstly mounted on the disc rotating and driving mechanism. The adjusting optical disc for the DVD is rotated in a prescribed direction to adjust the relative position of the objective lens to the light source so that the optical characteristics of one optical pickup have an optimum value. TOC (Table of Contents) information of the adjusting optical disc is read to access a prescribed position of the adjusting optical disc and adjust the inclination of the optical axis of the objective lens by using the adjusting optical disc.

Then, the rotation of the adjusting optical disc for the DVD is stopped to rotate the adjusting optical disc in a direction opposite to the prescribed direction. Thus, the relative position of the objective lens to the light source is adjusted so that the optical characteristics of the other optical pickup have an optimum value. The TOC information of the adjusting optical disc is read to access a prescribed position of the adjusting optical disc and adjust the inclination of the optical axis of the objective lens.

Here, in the adjusting optical disc, 8-16 modulated data is spirally recorded on both surfaces in the same physical format as that of the DVD.

As described above, in adjusting a pair of optical pickups used for recording or reproducing the optical disc such as the double-sided type DVD, when the optical characteristics upon reproducing the optical disc are adjusted, the adjusting optical disc needs to be mounted on the disc rotating and driving mechanism and rotated in the prescribed direction to adjust the optical characteristics in one optical pickup when one surface of the optical disc is reproduced. Then, after the rotation of the adjusting optical disc is stopped once, the adjusting optical disc needs to be rotated in the opposite direction to adjust the optical characteristics in the other optical pickup when the other surface of the optical disc is reproduced. In such an adjustment, an operation is necessary that the rotation of the adjusting optical disc is stopped and the adjusting optical disc is rotated in the opposite direction. Accordingly, it is difficult to efficiently adjust the pair of the optical pickups.

### DISCLOSURE OF THE INVENTION

It is an object of the present invention to provide a new optical disc for adjusting an optical pickup and an adjusting device and a method for an optical pickup that can solve the above-described problems in the usual adjustment of an optical pickup.

It is another object of the present invention to provide an optical disc for adjusting an optical pickup and an adjusting device and a method for an optical pickup in which the adjustment of a pair of optical pickups capable of recording and reproducing a double-sided type optical disc can be rapidly simplified.

It is still another object of the present invention to provide an optical disc for adjusting an optical pickup and an adjusting device and a method for an optical pickup in which the structure of the adjusting device can be simplified.

An optical disc for adjusting an optical pickup according to the present invention proposed to achieve the above-described objects comprises: a first signal recording part that is irradiated with a laser beam from one surface side; and a second signal recording part that is irradiated with the laser beam from the other surface side to record data so that a scanning direction by the laser beam is opposite to that of the first signal recording part.

In the first signal recording part of the adjusting optical disc, the data is recorded so as to form a first spiral recording track, and in the second signal recording part, the data is recorded so as to form a second recording track of a spiral shape in a direction opposite to that of the first recording track.

In the optical disc for adjusting an optical pickup according to the present invention, in the first signal recording part, the data may be recorded so as to form a first concentric circular recording track, and in the second signal recording part, the data may be recorded so as to form a second concentric circular recording track in opposite order to that of the first recording track.

An adjusting method for an optical pickup using an optical disc for adjusting an optical pickup comprises the steps of: mounting and rotating the optical disc for adjusting the optical pickup; then applying the laser beam to the signal recording part of the opposed side of the first and second signal recording parts of the adjusting optical disc from at least one of first and second optical pickups respectively disposed to be opposed to the surfaces of the adjusting disc; and detecting a reflected light from the opposed signal recording part to adjust the one optical pickup.

An adjusting device for an optical pickup according to the present invention comprises: a rotating and driving part for rotating and driving an optical disc for adjusting an optical pickup including: a first signal recording part that is irradiated with a laser beam from one surface side; and a second signal recording part that is irradiated with the laser beam from the other surface side to record data so that a scanning direction by the laser beam is opposite to that of the first signal recording part; and an adjusting mechanism part for applying the laser beam to the signal recording part of the opposed side of the first and second signal recording parts of the adjusting optical disc from at least one of first and second optical pickups respectively disposed to be opposed to the surfaces of the adjusting disc and detecting a reflected light from the opposed signal recording part to adjust the one optical pickup.

The adjusting device further comprises a control part for controlling the operations of the first and second optical pickups. The adjusting mechanism part includes a photodetector adjusting mechanism for adjusting an optical axis of a photodetector of the first or second optical pickup under an inoperative state of the focusing control and the tracking control of an objective lens of the one optical pickup by the control part.

Still other objects of the present invention and specific advantages obtained by the present invention will be more apparent from the description of embodiments explained by referring to the drawings.

### BRIEF DESCRIPTION OF THE DRAWINGS

FIG. 1 is a perspective view of an optical disc for adjusting an optical pickup to which the present invention is applied.

FIG. 2 is a plan view of the optical disc showing a first signal recording part viewed from a first disc base side.

FIG. 3 is a plan view of the optical disc showing a second signal recording part viewed from a second disc base side.

FIG. 4 is a sectional view showing the adjusting optical disc in which the first recording area of the first signal recording part is overlapped on the second recording area of the second signal recording part.

FIG. 5 is a sectional view showing the adjusting optical disc in which the first recording area of the first signal recording part is not overlapped on the second recording area of the second signal recording part.

FIG. 6 is a side view showing an adjusting device for an optical pickup according to the present invention.

FIG. 7 is a block diagram showing the structure of a first optical pickup and a second optical pickup.

FIG. 8 is a perspective view showing the structure of a fist base unit.

FIG. 9 is a perspective view showing the structure of a second base unit.

FIG. 10 is a block diagram showing a signal process in the adjusting device for the optical pickup and the control parts of respective mechanisms.

FIG. 11 is a flow chart showing an adjusting procedure of the optical pickup.

FIG. 12 is a perspective view showing another embodiment of an optical disc for adjusting an optical pickup to which the present invention is applied.

FIG. 13 is a plan view of the optical disc of another embodiment showing a first signal recording part viewed from a first disc base side.

FIG. 14 is a plan view of the optical disc of another embodiment showing a second signal recording part viewed from a second disc base side.

FIG. 15 is a sectional view showing another embodiment of the adjusting optical disc in which the first recording area of the first signal recording part is overlapped on the second recording area of the second signal recording part.

FIG. 16 is a sectional view showing another embodiment of the adjusting optical disc in which the first recording area of the first signal recording part is not overlapped on the second recording area of the second signal recording part.

### BEST MODE FOR CARRYING OUT THE INVENTION

Now, referring to the drawings, an optical disc for adjusting an optical pickup to which the present invention is applied, an adjusting device for an optical pickup using the adjusting optical disc and an adjusting method for an optical pickup using the adjusting device will be described below.

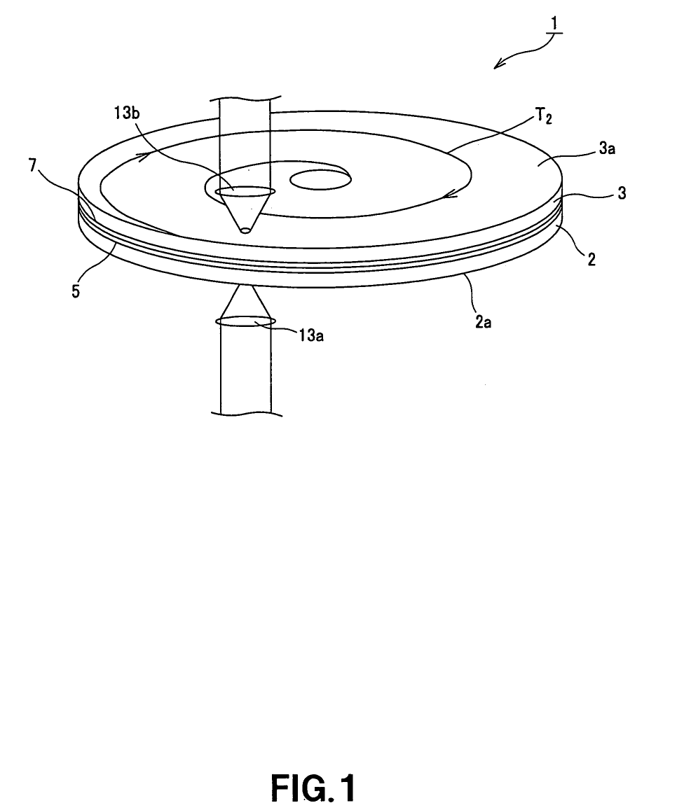

The optical disc 1 for adjusting the optical pickup according to the present invention is, as shown in FIG. 1, an adjusting optical disc used for adjusting a pair of optical pickups capable of reproducing a double-sided type DVD. The adjusting optical disc has a first disc base 2 having the thickness of 0.6 mm and light transmitting characteristics, and a second disc base 3 similarly having the thickness of 0.6 mm and light transmitting characteristics which are bonded to each other by an adhesive.

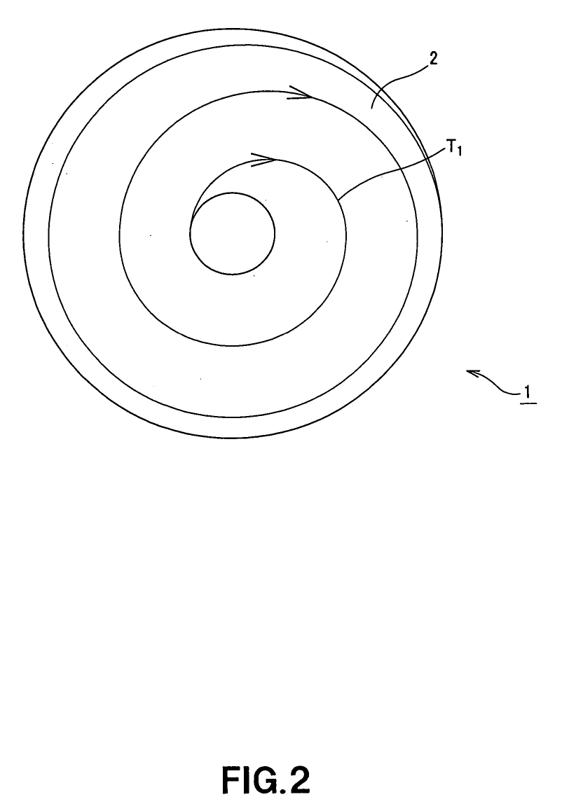

On the first disc base 2, a first signal recording part 5 is provided in the bonded surface side. The first signal recording part 5 is used when one optical pickup is adjusted. The first signal recording part 5 is provided at a position spaced by 0.6 mm from a reading surface 2a side of a first signal. In the first signal recording part 5, 8-16 modulated data is recorded in a pit pattern having a track pitch of 0.74 μm and a pit length of 0.4 to 1.87 μm so that the reflecting condition of the DVD substantially corresponds to that of a laser beam. Here, a recording track T1 provided in the first signal recording part 5 is, as shown in FIG. 2, spirally formed viewed from the recording surface 2a side of the first signal. On the first signal recording part 5, a reflecting film, a protective film or the like are formed.

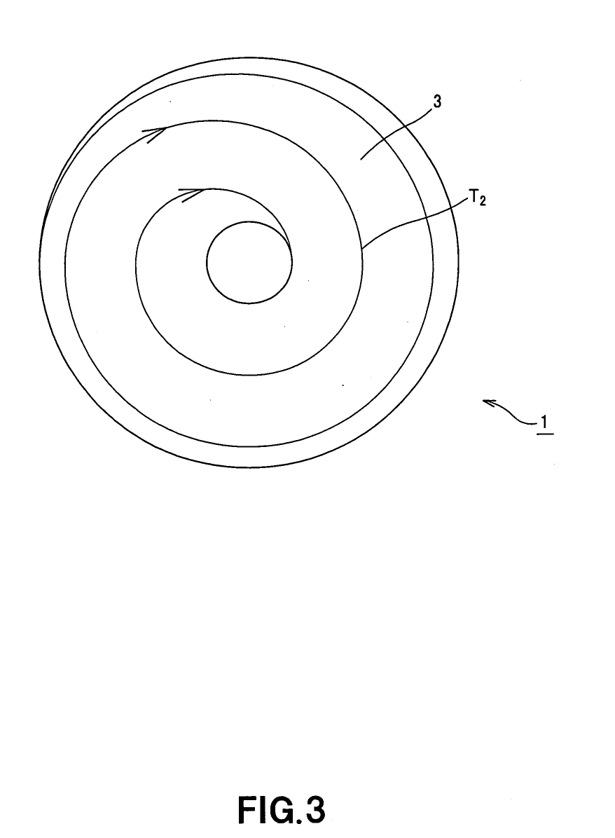

On the second disc base 3, a second signal recording part 7 is provided in the bonded surface side. The second signal recording part 7 is used when the other optical pickup is adjusted. The first signal recording part 7 is provided at a position spaced by 0.6 mm from a reading surface 3a side of a second signal. In the second signal recording part 7, 8-16 modulated data is recorded in a pit pattern having a track pitch of 0.74 μm and a pit length of 0.4 to 1.87 μm so that the reflecting condition of the DVD substantially corresponds to that of a laser beam. Here, a recording track T2 provided in the second signal recording part 7 is, as shown in FIG. 3, spirally formed in a direction opposite (refer this direction to as an opposite spiral direction, hereinafter) to the spiral direction of the recording tack T1 viewed from the recording surface 3a side of the second signal. On the second signal recording part 7, a reflecting film, a protective film or the like are formed.

On the first disc base 2, as shown in FIG. 2, the data recorded spirally in the first signal recording part 5 is directed from an inner peripheral side to an outer peripheral side. On the other hand, on the second disc base 3, as shown in FIG. 3, the data recorded in the opposite spiral direction on the second signal recording part 7 is directed from an outer peripheral side to an inner peripheral side. That is, the adjusting optical disc 1 is rotated in a prescribed direction for reproducing the first signal recording part 5 in the second disc base 2, so that the rotating direction of the second signal recording part 7 in the second disc base 3 is opposite to the prescribed direction. However, since the data is recorded in the opposite direction, the data recorded in the second signal recording part 7 can be read by the other optical pickup without stopping the rotation as described in the prior art.

Here, also in the DVD, a 8-16 modulation system is employed. Since the adjusting optical disc 1 is the optical disc for adjusting the pair of the optical pickups of a recording and/or reproducing device, the data does not need to be basically demodulated. Therefore, in the first signal recording part 5 and/or the second signal recording part 7, a modulation system used in a CD, that is, a 8-14 modulated data may be recorded. In this case, in the adjusting optical disc 1, a modulation system having a small number of bits after modulation, namely, a 8-14 modulation is employed as a modulation system, so that a process such as a demodulating process can be reduced.

In the first signal recording part 5 and the second signal recording part 7, data to which a Reed Solomon Product Code (RS-PC) employed in the DVD is added is recorded as an error correction code. As the error correction code, a Cross Interleave Reed-Solomon Code (CIRC) may be added.

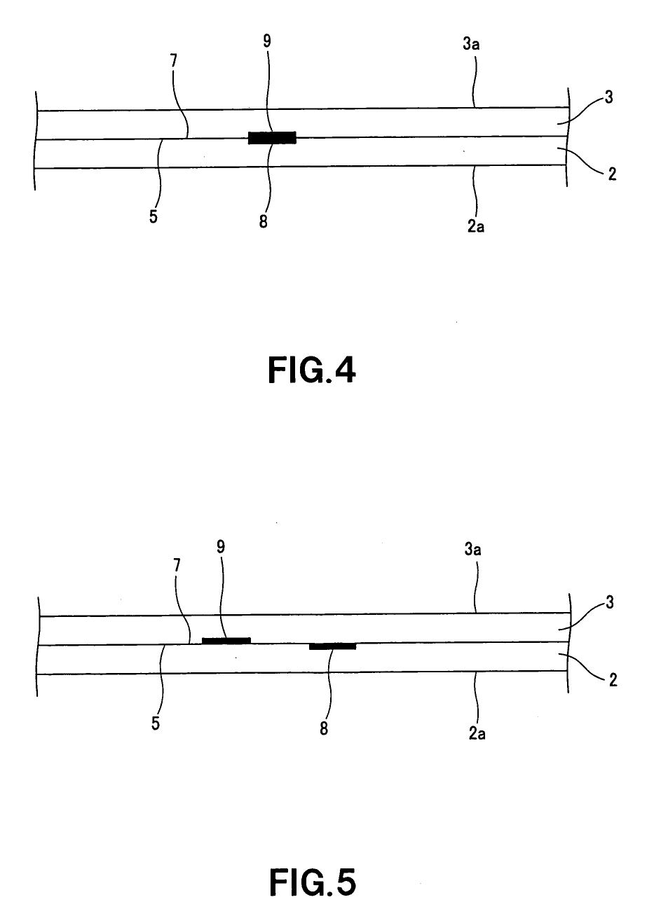

In the adjusting optical disc 1, as shown in FIG. 4, a first recording area 8 of adjusting data recorded in the first signal recording part 5 and a second recording area 9 of adjusting data recorded in the second signal recording part 7 are provided so as be overlapped on each other. That is, in the adjusting optical disc 1, the first recording area 8 and the second recording area 9 may have the same tracking control of objective lenses respectively in the pair of the optical pickups. Namely, when one optical pickup is located on a track, the other optical pickup can be located on a track.

As described above, in the adjusting optical disc 1, the first recording area 8 and the second recording area 9 are provided so as to be overlapped on each other, that is, the recording areas 8 and 9 are provided at positions spaced by the same distance in a radial direction from the center of the disc 1. Thus, the other optical pickup undergoes the same tracking control as that of the one optical pickup so that the other optical pickup can be located on the track and the pair of the optical pickups can be efficiently adjusted.

The first recording area 8 and the second recording area 9 provided in the adjusting optical disc 1 may be, as shown in FIG. 5, provided so as not to be overlapped on each other. That is, the recording areas 8 and 9 may be provided at positions spaced by different distances from each other in a radial direction from the center of the disc 1.

As described above, in the adjusting optical disc 1, the recording tracks T1 and T2 respectively provided in the first signal recording part 5 and the second signal recording part 7 are respectively provided spirally or in the opposite spiral direction. In the second signal recording part 7, the adjusting data is recorded in the opposite direction to that of the first signal recording part 5, that is, from the outer peripheral side to the inner peripheral side. Accordingly, the pair of the optical pickups can be continuously adjusted without stopping the rotation of the adjusting optical disc 1.

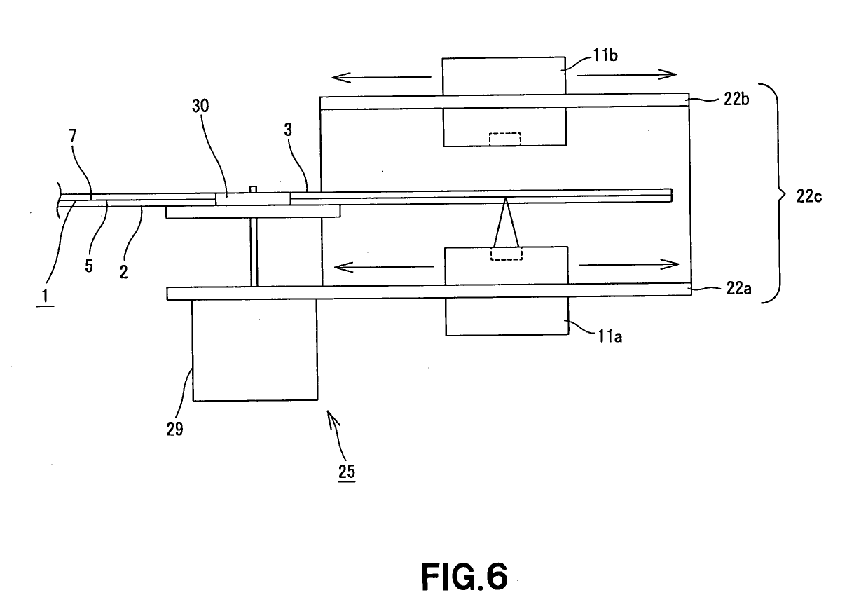

Now, the structure of the pair of the optical pickups adjusted by using the above-described adjusting optical disc 1 will be described by referring to FIGS. 6 to 10. The optical pickups can, for instance, record and/or reproduce a DVD.

As shown in FIG. 6, a first optical pickup 11a is provided so as to be opposed to the first signal recording part 5 in the adjusting optical disc 1 to reproduce data recorded on the recording track of the first signal recording part 5. A second optical pickup 11b is provided so as to be opposed to the second signal recording part 7 in the adjusting optical disc 1 to reproduce data recorded on the recording track of the second signal recording part 7.

The first optical pickup 11a is provided in a base 22a on which various kinds of controllers are mounted. The second optical pickup 11b is provided in a base 22b on which various kinds of controllers are mounted. Then, the base 22a and the base 22b are connected and fixed through a base support member 22c.

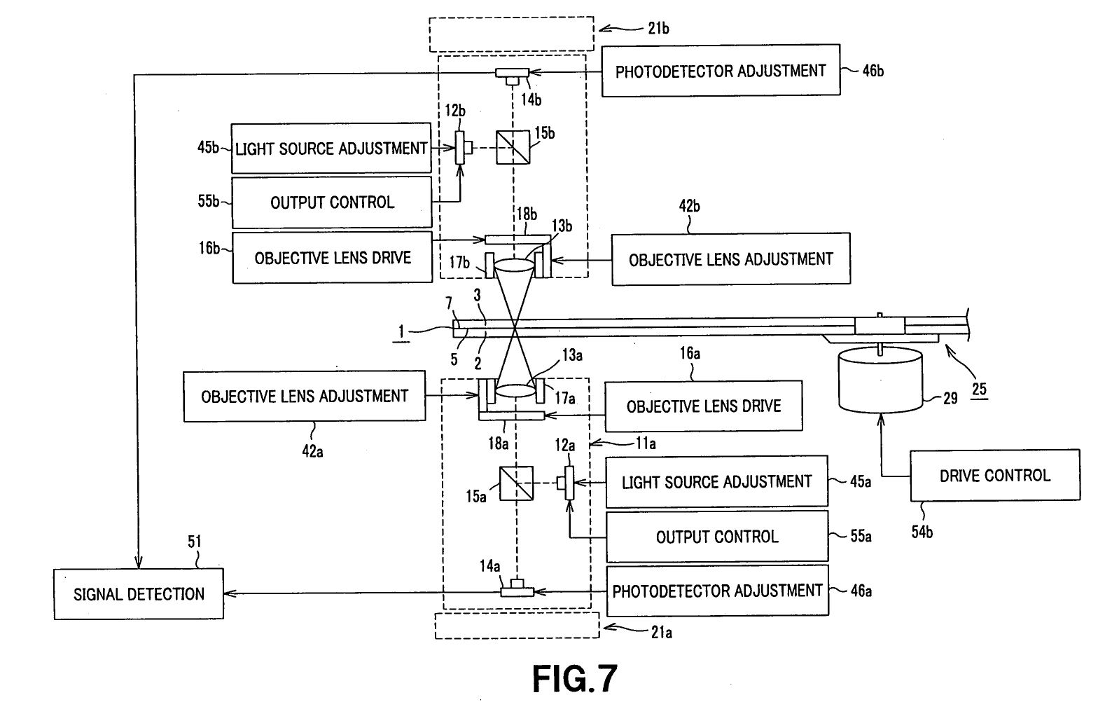

As shown in FIG. 7, the first optical pickup 11a includes a first light source 12a of a semiconductor laser or the like for emitting a laser beam as an optical beam having the wavelength of 635 to 650 nm, a first objective lens 13a for converging the laser beam outputted from the light source 12a on the first signal recording part 5 of the adjusting optical disc 1, a first photodetector 14a for receiving a reflected light reflected by the first signal recording part 5 of the adjusting optical disc 1, a first beam splitter 15a for guiding the laser beam outputted from the first light source 12a to the first objective lens 13a and guiding the reflected light reflected on the adjusting optical disc 1 to the first photodetector 14a, and a first objective lens driving part 16a for driving and displacing the first objective lens 13a in a focusing direction and a tracking direction.

As shown in FIG. 7, the second optical pickup 11b includes a second light source 12b of a semiconductor laser or the like for emitting a laser beam as an optical beam having the wavelength of 635 to 650 nm, a second objective lens 13b for converging the laser beam outputted from the second light source 12b on the second signal recording part 7 of the adjusting optical disc 1, a second photodetector 14b for receiving a reflected light reflected by the second signal recording part 7 of the adjusting optical disc 1, a second beam splitter 15b for guiding the laser beam outputted from the second light source 12b to the second objective lens 13b and guiding the reflected light reflected on the adjusting optical disc 1 to the second photodetector 14b, and a second objective lens driving part 16b for driving and displacing the second objective lens 13b in a focusing direction and a tracking direction.

The first and second objective lenses 13a and 13b are obtained respectively by, for instance, forming a hologram integrally with a lens. When the first signal recording part 5 and the second signal recording part 7 are irradiated with the laser beam as the optical beam, transmitted lights are respectively focused on the first signal recording part 5 and the second signal recording part 7. The first and second objective lenses 13a and 13b are respectively held by first and second lens holders 17a and 17b. The first and second lens holders 17a and 17b are respectively attached to first and second holder support members 18a and 18b through elastic support members that are not shown in the drawings. The first and second lens holders 17a and 17b holding the first and second objective lenses 13a and 13b are held by the elastic support members that are not shown in the drawings. Thus, while the first and second lens holders can be displaced in the focusing direction parallel to the directions of the optical axes of the first and second objective lenses 13a and 13b and in the tracking direction perpendicular to the directions of the optical axes of the first and second objective lenses 13a and 13b, the first and second lens holders 17a and 17b are attached to the first and second holder support members 18a and 18b.

The first and second objective lens driving parts 16a and 16b include focusing driving parts for driving and displacing the first and second objective lens 13a and 13b in the focusing direction and tracking driving parts for driving and displacing the first and second objective lens 13a and 13b in the tracking direction. Each of the driving parts includes a plurality of coils attached to the first and second lens holders 17a and 17b sides and magnets attached to the first and second holder support members 18a and 18b sides. Each driving part drives and displaces the first and second objective lenses 13a and 13b held by the first and second lens holders 17a and 17b in the focusing direction and the tracking direction in accordance with the action of a driving current based on a focus servo signal or a tracking servo signal supplied to each coil and a magnetic filed generated by the magnet. Thus, the laser beams respectively outputted from the first and second light sources 12a and 12b are controlled to follow the surface of the disc 1 and an eccentricity by the objective lens driving parts 16a and 16b, respectively focused on the first signal recording part 5 and the second signal recording part 7 of the adjusting optical disc 1, and applied so as to follow the recording tracks. The reflected lights respectively reflected on the first signal recording part 5 and the second signal recording part 7 are respectively detected by the first and second photodetectors 14a and 14b so that information signals respectively recorded in the signal recording parts 5 and 7 can be assuredly read.

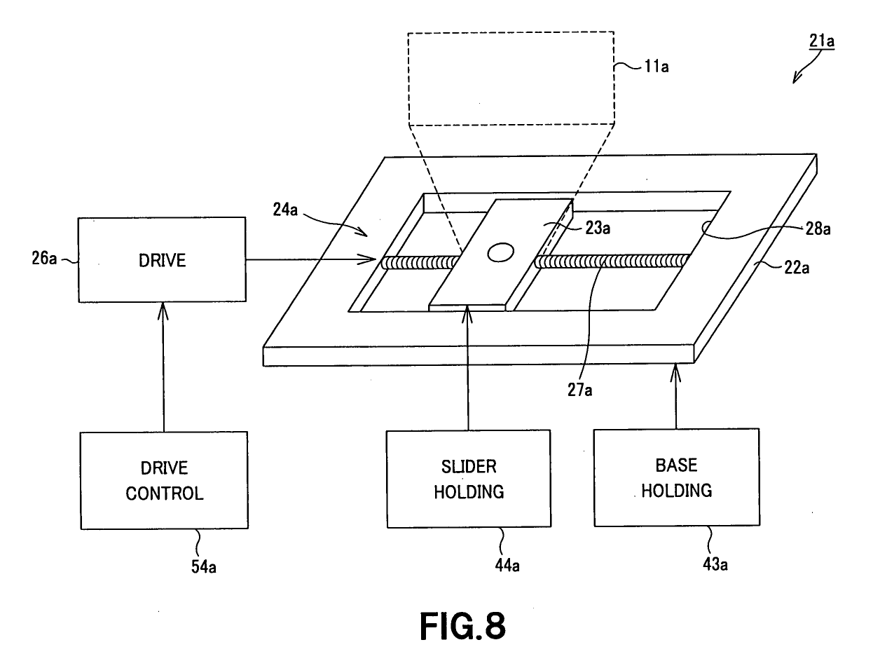

The first optical pickup 11a constructed as described above is, as shown in FIG. 8, attached to a first base unit 21a to be attached to the recording and/or reproducing device. The first base unit 21a has a first base 22a attached to a casing of the recording and/or reproducing device. In the first base 22a, a first slide member 23a to which the first optical pickup 11a is attached, a first feed mechanism 24a for moving the first slide member 23a to which the first optical pickup 11a is attached to the radial direction of the optical disc and a disc rotating and driving mechanism 25 for rotating and driving the optical disc are provided.

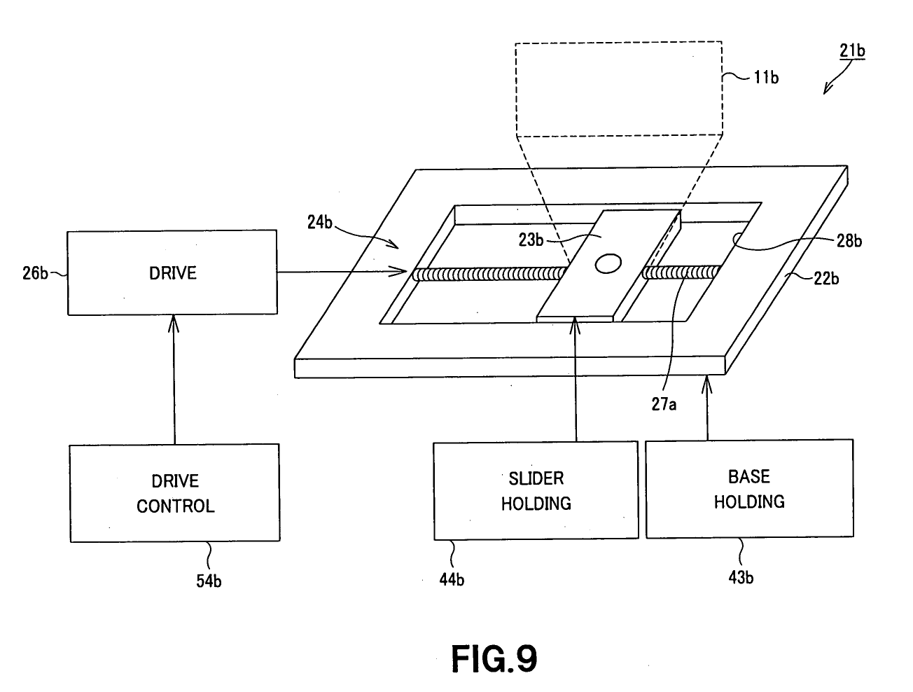

The second optical pickup 11b is, as shown in FIG. 9, attached to a second base unit 21b to be attached to the recording and/or reproducing device. The second base unit 21b has a second base 22b attached to a casing of the recording and/or reproducing device. In the second base 22b, a second slide member 23b to which the second optical pickup 11b is attached and a second feed mechanism 24b for moving the second slide member 23b to which the second optical pickup 11b is attached to the radial direction of the optical disc are provided.

To the first and second slide members 23a and 23b, the first optical pickup 11a and the second optical pickup 11b are respectively attached. The first and second optical pickups 11a and 11b are respectively disposed in first and second opening parts 28a and 28b formed along the radial direction of the optical disc on the bases 22a and 22b. On the first and second slide members 23a and 23b, for instance, positioning pins, which are not shown in the drawings, in the first and second slide members 23a and 23b are engaged with positioning holes, which are not shown in the drawings, provided in the first and second holder support members 18a and 18b. While the holder support members 18a and 18b are positioned with high accuracy, the holder support members 18a and 18b are fixed to the first and second slide members 23a and 23b by using an adhesive.

The first and second feed mechanisms 24a and 24b include, for instance, first and second driving motors 26a and 26b respectively attached to the first and second bases 22a and 22b and first and second feed screws 27a and 27b connected to the first and second driving motors 26a and 26b through a plurality of gear rows that are not shown in the drawings. The first and second feed screws 27a and 27b are disposed along the moving directions of the first optical pickup 11a and the second optical pickup 11b, that is, the radial direction of the optical disc and attached to the bases 22a and 22b so as to freely rotate. Engaging protrusions, which are not shown in the drawings, of the first and second slide members 23a and 23b to which the first optical pickup 11a and the second optical pickup 11b are attached are engaged with thread grooves provided on the peripheral surfaces of the first and second feed screws 27a and 27b. Thus, the first and second slide members 23a and 23b to which the first optical pickup 11a and the second optical pickup 11b are respectively attached are moved in the radial direction of the optical disc, for instance, the adjusting optical disc 1 by respectively rotating the first and second feed screws 27a and 27b through the driving motors 26a and 26b.

The disc rotating and driving mechanism 25 includes, as shown in FIG. 6, a driving motor 29 disposed in the back surface side of the first base 22a to which the first optical pickup 11a is attached and a disc table 30 attached to a rotating and driving shaft of the driving motor 29. The disc table 30 is engaged with the center hole of the adjusting optical disc 1 to center the adjusting optical disc 1 and integrally rotate the adjusting optical disc 1. The driving motor 29 rotates the adjusting optical disc 1 during reproducing the adjusting optical disc 1 so that the linear velocity achieves, for instance, a linear velocity of 3.49 m/sec specified by a DVD standard.

As shown in FIG. 6, the first base 22a of the first base unit 21a to which the first optical pickup 11a is attached and the second base 22b of the second base unit 21b to which the second optical pickup 11b is attached are fixed so as to be opposed to each other through the adjusting optical disc 1 by the base support member 22c as illustrated in the drawing.

An adjusting device 41 for adjusting the first optical pickup 11a and the second optical pickup 11b respectively attached to the first base unit 21a and the second base unit 21b is held, as shown in FIG. 6, under a state that the first base unit 21a to which the first optical pickup 11a is attached and the second base unit 21b to which the second optical pickup 11b is attached are respectively positioned on the base support member 22c. The adjusting device 41 includes, as shown in FIG. 7, first and second objective lens adjusting mechanisms 42a and 42b for holding the first and second holder support members 18a and 18b of the first optical pickup 11a and the second optical pickup 11b to respectively adjust the positions of the first and second objective lenses 13a and 13b, first and second base holding mechanisms 43a and 43b for respectively holding the first and second bases 22a and 22b, first and second slide member holding mechanisms 44a and 44b for respectively holding the first and second slide members 23a and 23b, first and second light source adjusting mechanisms 45a and 45b for respectively holding the first and second light sources 12a and 12b to adjust the positions of the first and second light sources 12a and 12b, first and second photodetector adjusting mechanisms 46a and 46b for respectively holding the first and second photodetectors 14a and 14b to adjust the positions of the first and second photodetectors 14a and 14b, and detecting mechanisms, which are not shown in the drawing, for respectively detecting the optical characteristics of the laser beams as the optical beams respectively outputted from the first and second light sources 12a and 12b.

The base support member 22c for holding the first base unit 21a and the second base unit 21b has a plurality of upright positioning shafts, which are not illustrated, for positioning the first and second bases 22a and 22b. The positioning shafts are engaged with positioning holes, which are not illustrated, provided in the first and second bases 22a and 22b to hold the first and second bases 22a and 22b in their positioned states.

The first and second objective lens adjusting mechanisms 42a and 42b include a pair of holding arms, which are not illustrated, for holding the first and second holder support members 18a and 18b to hold the first and second holder support members 18a and 18b by the pair of holding arms upon adjustment. The pair of the holding arms that hold the first and second holder support members 18a and 18b move the holder support members 18a and 18b in parallel in a radial direction (an X direction) parallel to the radial direction of the adjusting optical disc 1 and a tangential direction (a Y direction) perpendicular to the radial direction of the adjusting optical disc 1 under a state that the pair of the holding arms hold the first and second holder support members 18a and 18b. Further, while the pair of the holding arms hold the first and second holder support members 18a and 18b, the holding arms adjust a radial skew in which the first and second objective lenses 13a and 13b are inclined in the radial directions with respect to the optical axes and a tangential skew in which the first and second objective lenses 13a and 13b are inclined in the tangential direction with respect to the optical axes. The pair of the holding arms respectively move the first and second objective lenses 13a and 13b in the directions of optical axes to adjust optical paths from the first and second light sources 12a and 12b and the adjusting optical disc 1. Thus, the first and second holder support members 18a and 18b are adjusted in a direction of a plane parallel to the adjusting optical disc 1 and in the directions of the optical axes of the first and second objective lenses 13a and 13b perpendicular to the plane by the pair of the holding arms, and the inclinations of the first and second objective lenses 13a and 13b are respectively adjusted with high accuracy. At this time, the first and second holder support members 18a and 18b slightly float relative to the first and second slide members 23a and 23b. Spaces formed between the first and second slide members 23a and 23b and the first and second holder support members 18a and 18b are filled with an adhesive. Thus, while the first and second holder support members 18a and 18b are respectively highly accurately positioned to the first and second slide members 23a and 23b, the holder support members are fixed to the slide members.

The first and second base holding mechanisms 43a and 43b have a pair of holding arms, which are not shown in the drawing, for holding the first and second feed screws 27a and 27b forming the feed mechanisms 24a and 24b provided in the first and second bases 22a and 22b. When the first optical pickup 11a and the second optical pickup 11b are adjusted, the pair of holding arms hold both the end parts of the first and second feed screws 27a and 27b so that the first and second feed screws 27a and 27b are not flexibly deformed. Thus, the adjusted positions of the first optical pickup 11a and the second optical pickup 11b are not shifted.

The first and second slide member holding mechanisms 44a and 44b have a plurality of positioning pins, which are not shown in the drawing, for preventing the first and second slide members 23a and 23b from moving along the first and second feed screws 27a and 27b. When the first optical pickup 11a and the second optical pickup 11b are adjusted, the positioning pins are engaged with positioning holes, which are not shown in the drawing, provided in the first and second slide members 23a and 23b. Thus, the first and second slide members 23a and 23b are held under a state that the first and second slide members 23a and 23b are highly accurately positioned at prescribed positions in the radial direction of the adjusting optical disc 1.

The first and second light source adjusting mechanisms 45a and 45b have a pair of light source holding arms, which are not shown in the drawing, for respectively holding the first and second light sources 12a and 12b disposed in the first optical pickup 11a and the second optical pickup 11b. When the first optical pickup 11a and the second optical pickup 11b are adjusted, the light source holding arms hold the first and second light sources 12a and 12b in their positioned states and moves the first and second light sources 12a and 12b so that the centers of the first and second light sources 12a and 12b correspond to steady points of the first and second objective lenses 13a and 13b on their optical axes. The light source holding arms respectively rotate the first and second light sources 12a and 12b on light emitting points of the first and second light sources 12a and 12b as centers. Further, the light source holding arms respectively move the first and second light sources 12a and 12b in the directions of the optical axes of the first and second objective lenses 13a and 13b to adjust optical paths between the first and second light sources 12a and 12b and the adjusting optical disc 1.

The first and second photodetector adjusting mechanisms 46a and 46b include photodetector holding arms, which are not shown in the drawing, for holding the first and second photodetectors 14a and 14b respectively disposed in the first and second optical pickups 11a and 11b. When the first optical pickup 11a and the second optical pickup 11b are adjusted, the photodetector holding arms respectively hold the first and second photodetectors 14a and 14b in their positioned states to move the photodetectors so that the centers of the first and second photodetectors 14a and 14b correspond to the steady points of the first and second objective lenses 13a and 13b on their optical axes. The photodetector holding arms respectively rotate the first and second photodetectors 14a and 14b. Further, the photodetector holding arms respectively rotate the first and second photodetectors 14a and 14b in the directions of the optical axes to adjust optical paths.

The detecting mechanism includes CCD (Charge-Coupled Devices) cameras, which are not shown in the drawing, for detecting the optical beams emitted from the objective lenses 13a and 13b and a coma aberration deciding part, which are not shown in the drawing, for detecting a coma aberration. The CCD cameras are disposed on the optical axes of the first and second objective lenses 13a and 13b by a moving mechanism to detect the laser beams respectively emitted from the objective lenses 13a and 13b and output detected results to the coma aberration deciding part. The coma aberration deciding part detects a minimum value of the coma aberration.

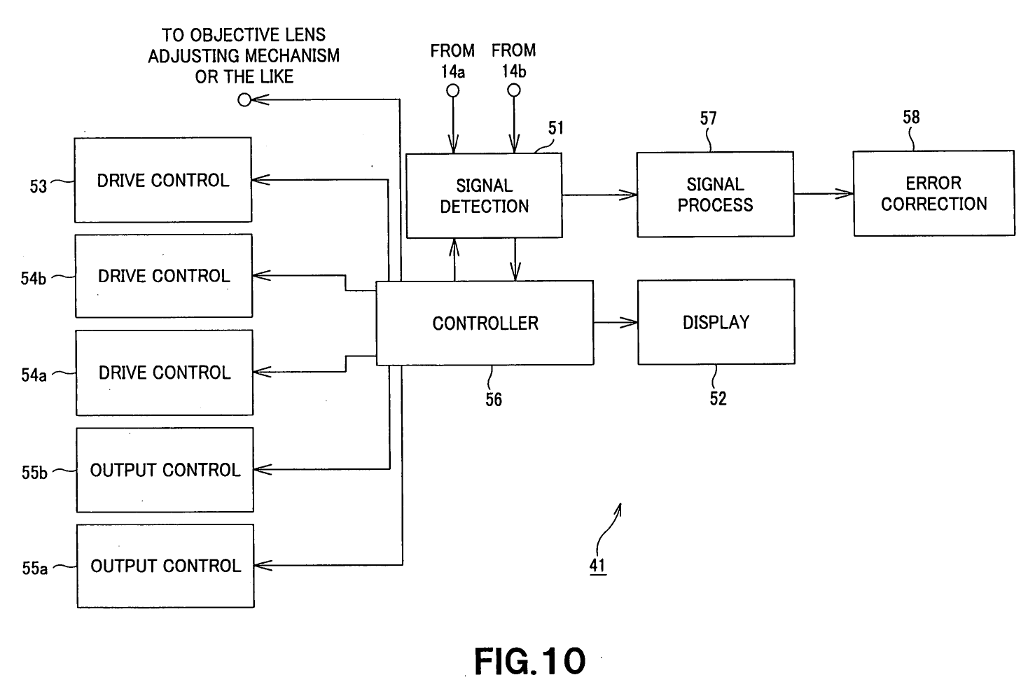

As shown in FIG. 10, the adjusting device 41 includes a signal detecting part 51 for detecting output signals respectively outputted from the photodetectors 14a and 14b for each of the optical pickups 11a and 11b, a display part 52 for displaying the signals detected by the signal detecting part 51, a driving control part 53 for controlling a driving motor 29 forming a disc rotating and driving mechanism 25, driving control parts 54a and 54b for controlling the first and second driving motors 26a and 26b forming the first and second feed mechanisms 24a and 24b of the first optical pickup 11a and the second optical pickup 11b, output control parts 55a and 55b for controlling the outputs of the laser beams as the optical beams of the first and second light sources 12a and 12b, and a controller 56 for controlling an entire operation. The controller 56 controls the driving control parts 53, 54a, and 54b, the output control parts 55a and 55b, the objective lens adjusting mechanisms 42a and 42b, the light source adjusting mechanisms 45a and 45b, and the photodetector adjusting mechanisms 46a and 46b.

Further, the adjusting device 41 includes a demodulating part 57 for demodulating the detected signals outputted from the signal detecting part 51 and an error correcting process part 58 for performing the error correcting process of data outputted from the demodulating part 57. In the adjusting device 41, the adjusting optical disc 1 shown in FIGS. 1, 4, and 5 is used. In the adjusting optical disc 1, adjusting data to which the RS-PC is added as an error correction code is recorded in the first signal recording part 5 and the second signal recording part 7 in accordance with the 8-16 modulation system. That is, in the first signal recording part 5 and the second signal recording part 7, the data modulated in the above described same modulation system and subjected to the above-described same error correction encoding process is recorded. Accordingly, the demodulating part 57 demodulates the 8-16 modulated data read from the first signal recording part 5 and the second recording part 7. The error correcting process part 58 carries out the error correcting process on the basis of the RS-PC of the data supplied from the demodulating part 57. For instance, the data outputted from the error correcting process part 58 is outputted to an inspector or the like, which is not shown in the drawing, for inspecting en error rate.

A method for adjusting the relative position of the first and second light sources 12a and 12b of the first optical pickup 11a and the second optical pickup 11b to the first and second objective lenses 13a and 13b, the positions of the objective lenses 13a and 13b to the optical axes, and the inclinations of the optical axes by using the adjusting device 41 constructed as described above and the adjusting optical disc 1 will be described below.

Firstly, the first base unit 21a and the second base unit 21b are held by, for instance, the base support member 22c as shown in FIG. 6. At this time, the positioning shafts are engaged with the positioning holes provided in the first and second bases 22a and 22b, so that the first base unit 21a and the second base unit 21b are held by the base support member 22c under a state that the first base unit 21a and the second base unit 21b are highly positioned. Further, the positioning pins are engaged with the positioning holes provided in the first and second slide members 23a and 23b, so that the first and second slide member holding mechanisms 44a and 44b hold the first and second slide members 23a and 23b under a state that the first and second slide members 23a and 23b are highly accurately positioned at prescribed positions in the radial direction of the adjusting optical disc 1. Further, the first and second base holding mechanisms 43a and 43b hold the first and second feed screws 27a and 27b so as not to rotate by the pair of holding arms and not to shift the first optical pickup 11a and the second optical pickup 11b from the adjusted positions. In the adjusting device 41, the first optical pickup 11a and the second optical pickup 11b are respectively mounted on and attached to the slide members 23a and 23b supported to be movable by the feed screws 27a and 27b on the first and seconds bases 22a and 22b.

The first and second holder support members 18a and 18b of the first optical pickup 11a and the second optical pickup 11b respectively mounted on the first and second slide members 23a and 23b are respectively held by the pair of holding arms of the first and second objective lens adjusting mechanisms 42a and 42b. The positions of the first and second objective lenses 13a and 13b are respectively three-dimensionally positioned relative to the first and second slide members 23a and 23b. The first and second light sources 12a and 12b are respectively held by the light source holding arms forming the first and second light source adjusting mechanisms 45a and 45b. The first and second photodetectors 14a and 14b are respectively held by the photodetector holding arms forming the first and second photodetector adjusting mechanisms 46a and 46b.

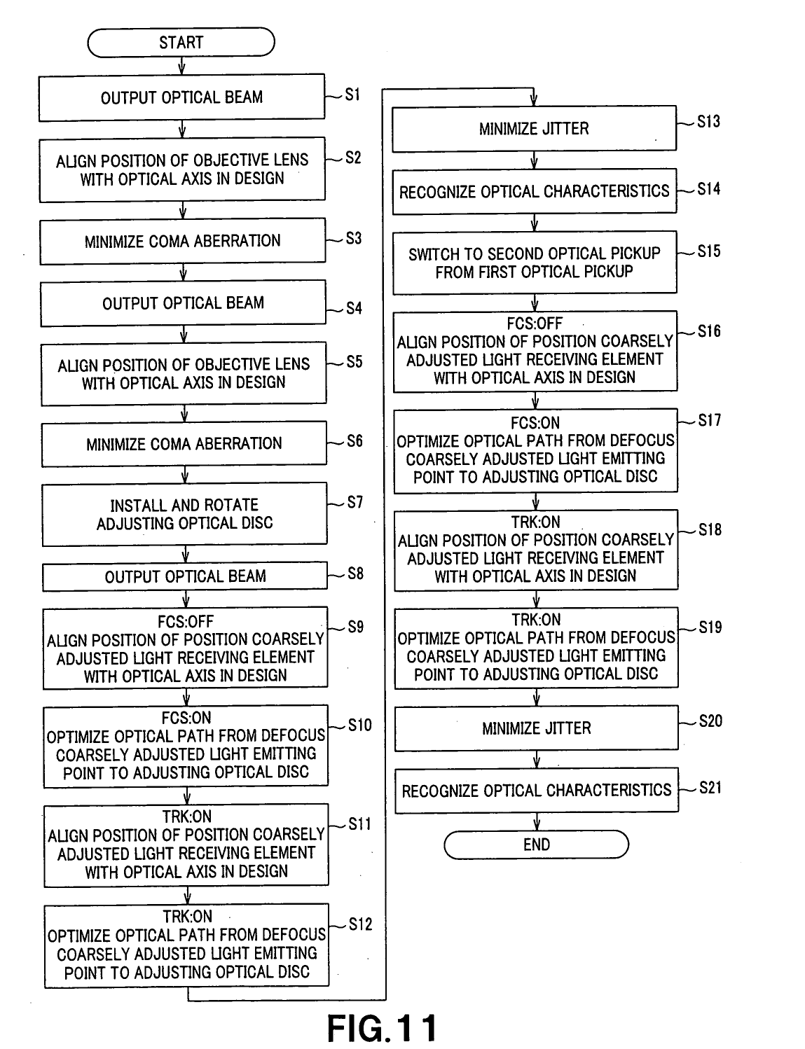

The adjusting device 41 firstly performs a positional adjustment of the first light source 12a and the first objective lens 13a of the first optical pickup 11a. That is, as shown in FIG. 11, the controller 56 controls the output control part 55a to output the laser beam as the optical beam having the wavelength of 635 to 650 nm for the DVD from the first light source 12a in step S1. Thus, the laser beam having the wavelength of 635 to 650 nm is outputted from the first light source 12a. At this time, the adjusting optical disc 1 is not mounted on the disc table 30 forming the disc rotating and driving mechanism 25.

In step S2, the controller 56 adjusts the first objective lens 13a relative to the first light source 12a, that is, the position of the first objective lens 13a, in other word, performs an adjustment to align the position of the optical axis of the first objective lens 13a with an optical axis in design. Specifically, the first objective lens adjusting mechanism 42a holding the first holder support member 18a drives and controls the holding arm holding the first holder support member 18a in accordance with the control of the controller 56 to move the first objective lens 13a in the radial direction (the X direction) and the tangential direction (the Y direction). The first light source adjusting mechanism 45a holding the first light source 12a moves so that the center of the first light source 12a corresponds to the steady point of the first objective lens 13a on the optical axis. Thus, the adjusting device 41 moves the positions of the first light source 12a and the first objective lens 13a to perform an adjustment to align the position of the optical axis of the first objective lens 13a with the optical axis in design.

In step S3, the controller 56 performs a process for minimizing the coma aberration. That is, the first objective lens adjusting mechanism 42a drives and controls the holding arm holding the first holder support member 18a in accordance with the control of the controller 56 to adjust the radial skew of the first objective lens 13a and the tangential skew of the first objective lens 13a, and adjust the inclination of the first objective lens 13a relative to the optical axis. Thus, the coma aberration is minimized. Namely, a detecting mechanism, which is not shown in the drawing, detects the laser beam converged on the first objective lens 13a by the CCD camera or the like and outputted from the light source 12a, obtains the coma aberration by the coma aberration deciding part and drives and controls the first objective lens adjusting mechanism 42a so as to have a minimum coma aberration on the basis of the value of the obtained coma aberration. When the minimum value of the coma aberration is obtained or detected, controller 56 drives the first objective lens adjusting mechanism 42a to hold or maintain the position of the first objective lens 13a having the minimum coma aberration.

In such a way, the first optical pickup 11a is adjusted so that the position of the optical axis of the first objective lens 13a corresponds to the optical axis in design. The inclination of the optical axis of the first objective lens 13a is adjusted so that the coma aberration becomes minimum and the relative position between the first light source 12a and the first objective lens 13a is adjusted.

Then, the adjusting device 41 performs a positional adjustment of the second light source 12b and the second objective lens 13b of the second optical pickup 11b. That is, the controller 56 controls the output control part 55b to output the laser beam as the optical beam having the wavelength of 635 to 650 nm from the second light source 12b in step S4. Thus, the laser beam having the wavelength of 635 to 650 nm is outputted from the second light source 12b. At this time, the adjusting optical disc 1 is not mounted on the disc table 30 forming the disc rotating and driving mechanism 25.

In step S5, the controller 56 adjusts the second objective lens 13b relative to the second light source 12b, that is, performs an adjustment to align the position of the optical axis of the second objective lens 13b with an optical axis in design. Specifically, the second objective lens adjusting mechanism 42b holding the second holder support member 18b drives and controls the holding arm holding the second holder support member 18b in accordance with the control of the controller 56 to move the second objective lens 13b in the radial direction (the X direction) and the tangential direction (the Y direction). The second light source adjusting mechanism 45b holding the second light source 12b moves so that the center of the second light source 12b corresponds to the steady point of the second objective lens 13b on the optical axis. Thus, the adjusting device 41 moves the positions of the second light source 12b and the second objective lens 13b to perform an adjustment to align the position of the optical axis of the second objective lens 13b with the optical axis in design.

In step S6, the controller 56 performs a process for minimizing the coma aberration. That is, the second objective lens adjusting mechanism 42b drives and controls the holding arm holding the second holder support member 18b in accordance with the control of the controller 56 to adjust the radial skew of the second objective lens 13b and the tangential skew of the second objective lens 13b, and adjust the inclination of the second objective lens 13b relative to the optical axis. Thus, the coma aberration is minimized. Namely, a detecting mechanism, which is not shown in the drawing, detects the laser beam converged on the second objective lens 13b by the CCD camera or the like and outputted from the second light source 12b, detects and obtains the coma aberration by the coma aberration deciding part and drives and controls the second objective lens adjusting mechanism 42b so as to have a minimum coma aberration on the basis of the value of the detected or obtained coma aberration. When the minimum value of the coma aberration is detected, the controller 56 drives the second objective lens adjusting mechanism 42b to hold or maintain the position of the second objective lens 13b having the minimum coma aberration.

In such a way, the second optical pickup 11b is adjusted so that the position of the optical axis of the second objective lens 13b corresponds to the optical axis in design. The inclination of the optical axis of the second objective lens 13b is adjusted so that the coma aberration becomes minimum and the relative position between the second light source 12b and the second objective lens 13b is adjusted.

In step S7, the adjusting optical disc 1 is mounted on the disc table 30 forming the disc rotating and driving mechanism 25. The driving control part 53 drives and controls the driving motor 29 so that the linear velocity upon rotating the adjusting optical disc 1 in a prescribed direction is, for instance, 3.49 m/sec specified by the DVD standard in accordance with the control of the controller 56. Here, the adjusting optical disc 1 mounted on the disc table 30 has, as shown in FIGS. 1, 4, and 5, the first recording part 5 for adjusting the first optical pickup 11a and the second signal recording part 7 for adjusting the second optical pickup 11b. In the signal recording parts 5 and 7, the recording tracks are respectively provided spirally or in the opposite spiral direction. In the adjusting optical disc 1 shown in FIG. 4, the first recording area 8 provided in the first signal recording part 5 is disposed so as to be overlapped on the second signal recording area 9 provided in the second signal recording part 7. In the adjusting optical disc 1 shown in FIG. 5, the first recording area 8 provided in the first signal recording part 5 is disposed so as not to be overlapped on the second recording area 9 provided in the second signal recording part 7. As the adjusting data recorded on the first signal recording part 5 and the second signal recording part 7, the 8-16 modulated data used in the DVD standard is recorded.

Then, in step S8, the adjustment of the first optical pickup 11a will be described. Initially, when the adjusting optical disc 1 shown in FIGS. 1, 4, and 5 is mounted on the disc table 30, the first optical pickup 11a is firstly fed and moved to the position of the first recording area 8 of the fist signal recording part 5. That is, the controller 56 drives the first driving motor 26a by the driving control part 54 to move the first optical pickup 11a to a position where the first recording area 8 can be read.

The controller 56 controls the output control part 55a so as to output the laser beam having the wavelength of 635 to 650 nm from the first light source 12a. Thus, the laser beam having the wavelength of 635 to 650 nm for the DVD is outputted from the first light source 12a and the first photodetector 14a detects the reflected light reflected by the first signal recording part 5 of the adjusting optical disc 1.

In step S9, the adjusting device 41 performs a coarse adjustment to align the position of the first photodetector 14a with the position of an optical axis in design. At this time, the controller 56 controls to turn off the focusing control and the tracking control by the first objective lens driving part 16a. Under the off state, the first photodetector adjusting mechanism 46a holding the first photodetector 14a moves the photodetector holding arm holding the first photodetector 14a under the control of the controller 56 to perform a coarse adjustment for aligning the position of the first photodetector 14a with the position of the optical axis in design.

In step S10, the adjusting device 41 performs a coarse adjustment to optimize an optical path from the first light source 12a, that is, the light emitting point of the laser beam to the adjusting optical disc 1. At this time, the controller 56 turns on the focusing control for focusing the first objective lens driving part 16a on the first signal recording part 5 and turns off the tracking control. This focusing control is performed by, for instance, what is called an astigmatism method. The controller 56 controls the first objective lens adjusting mechanism 42a holding the first objective lens 13a, the first light source adjusting mechanism 45a holding the first light source 12a, and the photodetector adjusting mechanism 46a holding the first photodetector 14a to perform a coarse adjustment for optimizing the optical path from the light emitting point of the laser beam to the adjusting optical disc 1. For instance, the position of the first light source 12a in the direction of an optical axis is adjusted so that the laser beam is focused on the first signal recording part 5 by the first objective lens 13a to optimize the optical path. The position of the first photodetector 14a in the direction of an optical axis is likewise adjusted so that the reflected light is focused on the first photodetector 14a.

In step S11, the adjusting device 41 performs a fine adjustment to align the position of the first photodetector 14a with the position of an optical axis in design. At this time, the controller 56 controls the first objective lens driving part 16a to turn on both the focusing control and the tracking control so that the spiral recording track can be scanned while the optical beam is focused on the first signal recording part 5. The tracking control is performed by, for instance, what is called a push-pull method or a DPD (differential phase detection) method or the like. Under this state, in the first photodetector adjusting mechanism 46a holding the first photodetector 14a, the controller 56 moves the photodetector holding arm holding the first photodetector 14a in accordance with an output signal from the first photodetector 14a to perform a fine adjustment for aligning the position of the first photodetector 14a with the position of the optical axis in design.

In step S12, the adjusting device 41 performs a fine adjustment to optimize the optical path from the first light source 12a, that is, the light emitting point of the laser beam to the adjusting optical disc 1. At this time, the controller 56 controls the first objective lens driving part 16a to turn on both the focusing control and the tracking control so that the spiral recording track can be scanned while the laser beam is focused on the first signal recording part 5. The controller 56 controls the first objective lens adjusting mechanism 42a holding the first objective lens 13a, the first light source adjusting mechanism 45a holding the first light source 12a, and the photodetector adjusting mechanism 46a holding the first photodetector 14a to perform a fine adjustment for optimizing the optical path from the light emitting point of the laser beam to the adjusting optical disc 1.

Then, the adjusting device 41 performs a skew adjustment. Here, in the skew adjustment, an adjustment is carried out so as to satisfy the permissibility of an inclination determined by the DVD standard.

In step S13, the controller 56 drives the first objective lens adjusting mechanism 42a so that the value of a jitter generated in the signal detecting part 51 is minimum to adjust the inclination of the optical axis of the first objective lens 13a.

In step S14, the adjusting device 41 recognizes optical characteristics upon reproducing the DVD in the first optical pickup 11a. For instance, the adjusting device 41 controls the first output control part 55a so that the level of an RF signal generated in the signal detecting part 51 by the output signal from the first photodetector 14a that detects the returning optical beam reflected by the first signal recording part 5 has an optimum value to adjust and recognize the output level of the first light source 12a.

After that, the adjusting device 41 that completes the optical adjustment of the first optical pickup 11a performs, for instance, an inspection of the error rate of the first optical pickup 11a.

Then, the adjusting device 41 adjusts the second optical pickup 11b for reproducing the second signal recording part 7. Here, when the adjusting optical disc 1 shown in FIG. 4, that is, the optical disc in which the recording area 8 of the first signal recording part 5 is overlapped on the second recording area 9 of the second signal recording part 7 is mounted on the disc table 30, the controller 56 stops, in step S15, the output of the laser beam from the first light source 12a of the first optical pickup 11a to perform a switching so that the laser beam as the optical beam is outputted from the second light source 12b of the second optical pickup 11b. That is, the output control part 55b controls the second light source 12b to emit the laser beam having the wavelength of 635 to 650 nm. The second photodetector 14b receives the reflected light reflected by the second signal recording part 7 of the adjusting optical disc 1. When the adjusting optical disc 1 is mounted on the disc table 30, the second optical pickup 11b attached to the second slide member 23b is not moved in the radial direction of the optical disc 1.

When the adjusting optical disc 1 shown in FIG. 5, that is, the optical disc in which the recording area 8 of the first signal recording part 5 is not overlapped on the second recording area 9 of the second signal recording part 7 is mounted on the disc table 30, the second slide member 23b to which the second optical pickup 11b is attached is fed and moved in the radial direction of the adjusting optical disc 1 to a position where the first recording area 8 can be read. After that, the controller 56 stops the output of the laser beam from the first light source 12a of the first optical pickup 11a to perform a switching so that the laser beam is outputted from the second light source 12b of the second optical pickup 11b. That is, the output control part 55b controls the second light source 12b to emit the laser beam having the wavelength of 635 to 650 nm. The second photodetector 14b receives the reflected light reflected by the second signal recording part 7 of the adjusting optical disc 1.

In step S16, the adjusting device 41 performs a coarse adjustment to align the position of the second photodetector 14b with the position of an optical axis in design. At this time, the controller 56 controls to turn off the focusing control and the tracking control by the second objective lens driving part 16b. Under the off state, the second photodetector adjusting mechanism 46b holding the second photodetector 14b moves the photodetector holding arm holding the second photodetector 14b under the control of the controller 56 to perform a coarse adjustment for aligning the position of the second photodetector 14b with the position of the optical axis in design.

In step S17, the adjusting device 41 performs a coarse adjustment to optimize an optical path from the second light source 12b, that is, the light emitting point of the laser beam to the adjusting optical disc 1. At this time, the controller 56 turns on the focusing control for focusing on the second signal recording part 7 by the second objective lens driving part 16b and turns off the tracking control. This focusing control is performed by, for instance, what is called an astigmatism method. The controller 56 controls the second objective lens adjusting mechanism 42b holding the second objective lens 13b, the second light source adjusting mechanism 45b holding the second light source 12b, and the photodetector adjusting mechanism 46b holding the second photodetector 14b to perform a coarse adjustment for optimizing the optical path from the light emitting point of the laser beam to the adjusting optical disc 1. The coarse adjustment for optimizing the optical path is the same as that in the first optical pickup 11a.

In step S18, the adjusting device 41 performs a fine adjustment to align the position of the second photodetector 14b with the position of an optical axis in design. At this time, the controller 56 controls the second objective lens driving part 16b to turn on both the focusing control and the tracking control so that the recording track in the opposite spiral direction can be scanned while the optical beam is focused on the second signal recording part 7. The tracking control is performed by, for instance, what is called a push-pull method or a DPD method or the like. Under the off state, the second photodetector adjusting mechanism 46b holding the second photodetector 14b moves the photodetector holding arm holding the second photodetector 14b under the control of the controller 56 to perform a fine adjustment for aligning the position of the second photodetector 14b with the position of the optical axis in design. The fine adjustment of the second photodetector 14b is carried out in the same manner as the coarse adjustment in the first photodetector 14a.

In step S19, the adjusting device 41 performs a fine adjustment to align the position of the second photodetector 14b with the position of the optical path in design. At this time, the controller 56 controls the second objective lens driving part 16b to turn on both the focusing control and the tracking control so that the recording track in the opposite spiral direction can be scanned while the optical beam is focused on the second signal recording part 7. The controller 56 controls the second objective lens adjusting mechanism 42b holding the second objective lens 13b, the second light source adjusting mechanism 45b holding the second light source 12b, and the second photodetector adjusting mechanism 46b holding the second photodetector 14b to perform a fine adjustment for optimizing the optical path from the light emitting point of the laser beam to the adjusting optical disc 1.

Then, the adjusting device 41 performs a skew adjustment. Here, in the skew adjustment, an adjustment is carried out so as to satisfy the permissibility of an inclination determined by the DVD standard.

The controller 56 controls the second slider holding mechanism 44b to move the second slider member 23b to which the second optical pickup 11b is attached in the radial direction of the adjusting optical disc 1 to a position where the second recording area 9 can be read.

In step S20, the controller 56 drives the second objective lens adjusting mechanism 42b so that the value of a jitter generated in the signal detecting part 51 is minimum to adjust the inclination of the optical axis of the objective lens 13b.

In step S21, the adjusting device 41 recognizes optical characteristics upon reproducing the DVD in the second optical pickup 11b. For instance, the adjusting device 41 controls the second output control part 55b so that an RF signal generated in the signal detecting part 51 by the output signal from the second photodetector 14b that detects the reflected light reflected by the second signal recording part 7 has an optimum value to adjust and recognize the output level of the second light source 12b.

After that, the adjusting device 41 that completes the optical adjustment of the second optical pickup 11b performs, for instance, an inspection of the error rate of the second optical pickup 11b.

In such a way, the first optical pickup 11a and the second optical pickup 11b that finish the adjustment of the optical characteristics are respectively fixed to the first and second slide members 23a and 23b by the adhesive and mounted on the recording and/or reproducing device of the optical disc.

As described above, the adjustment of the first optical pickup 11a and the second optical pickup 11b can be smoothly carried out without stopping the rotation of the adjusting optical disc like the prior art by using the adjusting optical disc 1 in which the data is recorded spirally or in the opposite spiral direction respectively in the signal recording parts 5 and 7 and the data is recorded in the opposite directions to each other.

In case the adjusting optical disc 1 shown in FIG. 4, that is, the adjusting optical disc 1 in which the first recording area 8 of the first signal recording part 5 is overlapped on the second recording area 9 of the second signal recording part 7 is mounted, when the adjustment of the first optical pickup 11a is switched to the adjustment of the second optical pickup 11b, the first optical pickup 11a and the second optical pickup 11b are synchronously subjected to the tracking control. Thus, the second optical pickup 11b is already located on the track, so that a switching operation can be smoothly carried out.

In the above-described embodiment, the structure is described that after the first optical pickup 11a is adjusted, the second optical pickup 11b is adjusted without stopping the rotation of the adjusting optical disc 1. However, the first optical pickup 11a and the second optical pickup 11b may be adjusted at the same time. At this time, in the adjusting optical disc 1, the data needs to be recorded from the inner peripheral side to the outer peripheral side on the recording track of the second signal recording part 7.

In this case, output signals from the first and second photodetectors 14a and 14b need to be respectively individually processed so that the first optical pickup 11a and the second optical pickup 11b can be simultaneously controlled by the controller 56. In that case, the signal detecting part or the like are respectively provided to correspond to the first optical pickup 11a and the second optical pickup 11b.

When the first optical pickup 11a and the second optical pickup 11b can be adjusted at the same time, an adjusting time can be more shortened, so that the pair of the optical pickups can be adjusted in very short time.

The adjustment of the first optical pickup 11a in the above-described step S8 to the step S14 and the adjustment of the second optical pickup 11b in the step S15 to the step S19 are not limited to the example shown in FIG. 11. An order for adjusting the first optical pickup 11a and the second optical pickup 11b may be switched.

When the first optical pickup 11a and the second optical pickup 11b are made of light emitting and light receiving elements having light sources formed integrally with photodetectors, parts except the first and second objective lenses 13a and 13b are integrally formed. Accordingly, after the coma aberration is adjusted in the step S1 to the step S6, at least the adjustments carried out in the step S8 to the step S12 and the step S15 to the step S19 may be omitted. That is, when the first optical pickup 11a and the second optical pickup 11b are made of the above-described light emitting and light receiving elements, only the positions of the objective lenses 13a and 13b may be adjusted.

In the above-described embodiment, the disc is explained as an example of the optical disc for adjusting the optical pickup that the recording track is provided spirally in one signal recording surface and the recording track is provided on the other signal recording surface in the opposite direction to that of the one signal recording surface. The present invention is not limited to the adjusting optical disc in which the recording track is formed spirally. An adjusting optical disc for the optical pickup in which a recording track may be concentrically formed.

Now, an example for adjusting the optical pickup by using the adjusting optical disc in which the recording track is concentrically formed will be described below.

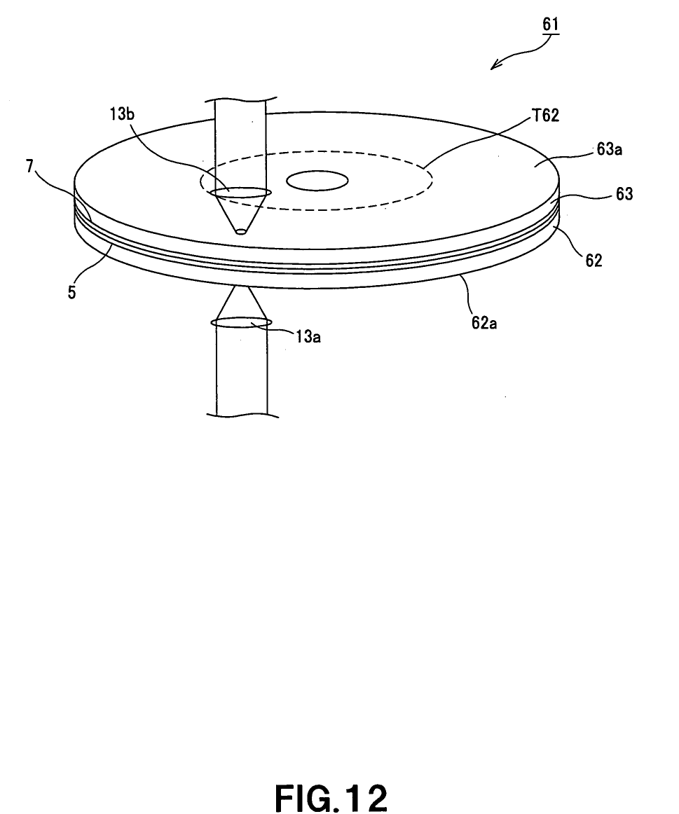

Specifically, as shown in FIG. 12, the optical disc 61 for adjusting the optical pickup is an adjusting optical disc used for adjusting a pair of optical pickups capable of reproducing a double-sided type DVD. The adjusting optical disc has a first disc base 62 having the thickness of 0.6 mm and light transmitting characteristics, and a second disc base 63 similarly having the thickness of 0.6 mm and light transmitting characteristics which are bonded to each other by an adhesive.

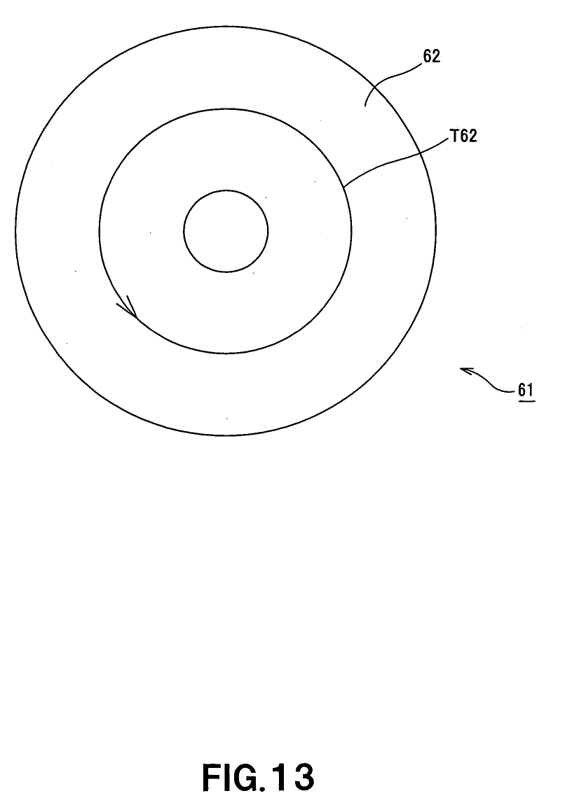

On the first disc base 62, a first signal recording layer 65 is provided in the bonded surface side. The first signal recording layer 65 is used when one optical pickup is adjusted. The first signal recording layer 65 is provided at a position spaced by 0.6 mm from a reading surface 62a side of a first signal. In the first signal recording layer 65, 8-16 modulated data is recorded in a pit pattern having a track pitch of 0.74 μm and a pit length of 0.4 to 1.87 μm so that the reflecting condition of the DVD substantially corresponds to that of a laser beam. Here, a recording track T61 provided in the first signal recording layer 65 is, as shown in FIG. 13, concentrically formed viewed from the recording surface 62a side of the first signal. When one optical pickup is adjusted, the one optical pickup is not moved in the radial direction. On the first signal recording layer 65, a reflecting film, a protective film or the like are formed.

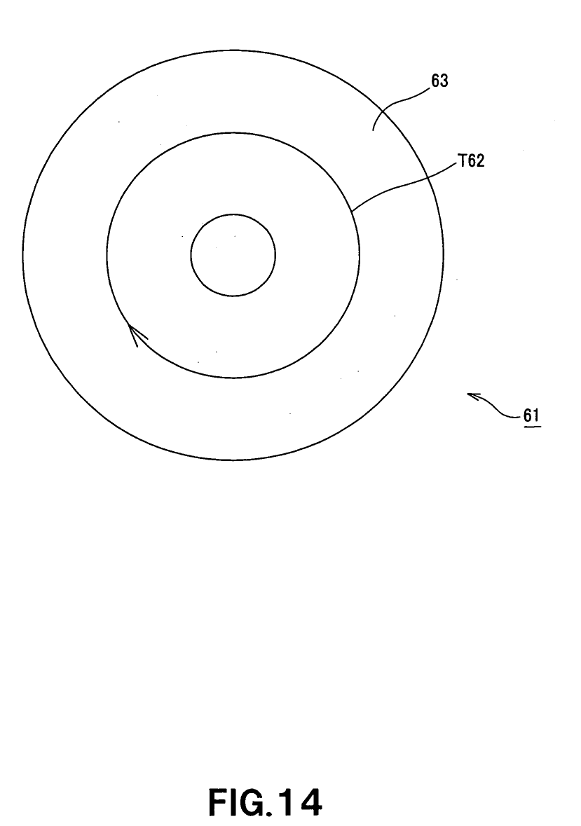

On the second disc base 63, a second signal recording layer 67 is provided in the bonded surface side. The second signal recording layer 67 is used when the other optical pickup is adjusted. The second signal recording layer 67 is provided at a position spaced by 0.6 mm from a reading surface 63a side of a second signal. In the second signal recording layer 67, 8-16 modulated data is recorded in a pit pattern having a track pitch of 0.74 μm and a pit length of 0.4 to 1.87 μm so that the reflecting condition of the DVD substantially corresponds to that of a laser beam. Here, a recording track T62 provided in the second signal recording layer 67 is, as shown in FIG. 14, concentrically formed viewed from the recording surface 63a side of the second signal. When the other optical pickup is adjusted, the other optical pickup is not moved in the radial direction. On the second signal recording layer 67, a reflecting film, a protective film or the like are formed.

In the second disc base 63, as shown in FIG. 14, the data is recorded concentrically on the second signal recording layer 67 in the opposite direction to that of the data recorded concentrically on the first signal recording layer 65 in the first disc base 62 as shown in FIG. 13. That is, the adjusting optical disc 61 is rotated in a prescribed direction for reproducing the first signal recording layer 65 in the first disc base 62, so that the rotating direction of the second signal recording layer 67 in the second disc base 63 is opposite to the prescribed direction. However, since the data is recorded in the opposite direction, the data recorded in the second signal recording layer 67 can be read by the other optical pickup without stopping the rotation.

Here, in the DVD, a 8-16 modulation system is employed. Since the adjusting optical disc 61 is the optical disc for adjusting the pair of the optical pickups, the data does not need to be basically demodulated. Therefore, in the first signal recording layer 65 and/or the second signal recording layer 67, 8-14 modulated data may be recorded like a CD. That is, in the adjusting optical disc 61, a modulation system having a small number of bits after modulation, namely, a 8-14 modulation is employed as a modulation system, so that a process such as a demodulating process can be reduced.

In the first signal recording layer 65 and the second signal recording layer 67, data to which a Reed Solomon Product Code (RS-PC) employed in the DVD is added as an error correction code is recorded. As the error correction code, a Cross Interleave Reed-Solomon Code (CIRC) may be added.

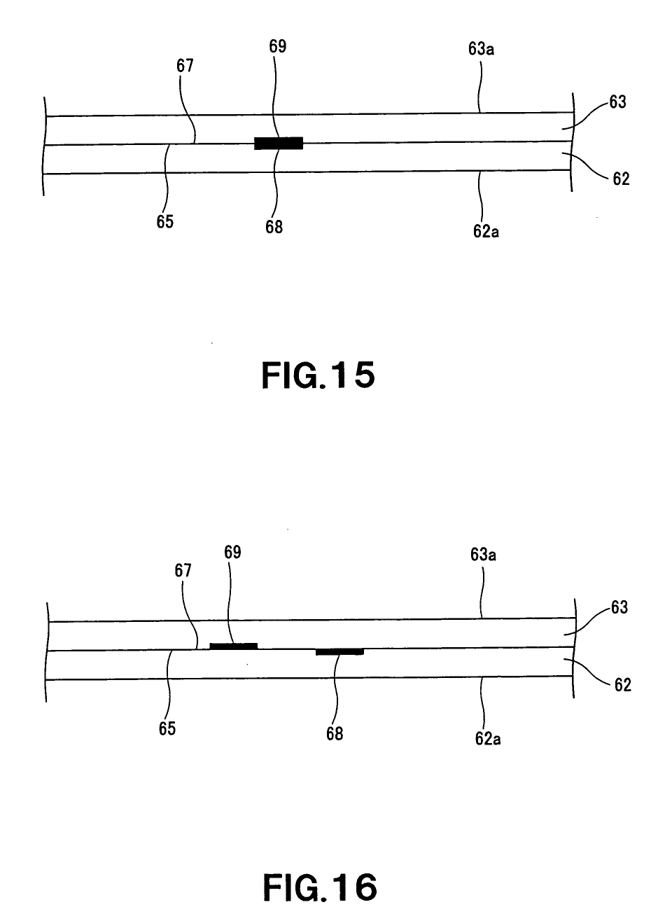

In the adjusting optical disc 61, as shown in FIG. 15, a first recording area 68 of adjusting data recorded in the first signal recording layer 65 and a second recording area 69 of adjusting data recorded in the second signal recording layer 67 are provided so as be overlapped on each other. That is, in the adjusting optical disc 61, the first recording area 68 and the second recording area 69 may have the same tracking control of objective lenses respectively in the pair of the optical pickups. Namely, when one optical pickup is located on a track, the other optical pickup can be located on a track.

As described above, in the adjusting optical disc 61, the first recording area 68 and the second recording area 69 are provided so as to be overlapped on each other. Thus, the other optical pickup undergoes the same tracking control as that of the one optical pickup so that the other optical pickup can be located on the track and the pair of the optical pickups can be efficiently adjusted.

The first recording area 68 and the second recording area 69 provided in the adjusting optical disc 61 may be, as shown in FIG. 16, provided so as not to be overlapped on each other.

As described above, in the adjusting optical disc 61, the recording tracks T61 and T62 respectively provided in the first signal recording layer 65 and the second signal recording layer 67 are respectively provided concentrically. In the second signal recording layer 67, the adjusting data is recorded in the opposite direction to that of the first signal recording layer 65. Accordingly, the pair of the optical pickups can be continuously adjusted without stopping the rotation of the adjusting optical disc 61. Further, in the adjusting optical disc 61, when the corresponding signal recording layer is reproduced by at least one of the optical pickups, the optical pickup does not need to be moved to the radial direction of the adjusting optical disc 61. Thus, the optical pickup can be efficiently adjusted.

An adjusting method of the optical pickup 11 using the adjusting optical disc 61 can be performed in the same manner as the adjusting method of the optical pickup using the above-described adjusting optical disc 1.

It is to be understood by a person with ordinary skill in the art that the present invention is not limited to the above-described embodiments and various changes, substitutions or equivalence thereto may be made without departing the attached claims and the gist thereof.

### INDUSTRIAL APPLICABILITY

As described above, in the present invention, the optical disc for adjusting the optical pickup is used that comprises the first signal recording part that is irradiated with a laser beam from one surface side; and the second signal recording part that is irradiated with the laser beam from the other surface side to record data so that a scanning direction by the laser beam is opposite to that of the first signal recording part to adjust a pair of optical pickups capable of recording and reproducing a double-sided type optical disc. Thus, the pair of optical pickups can be continuously adjusted.

1. An optical disc for adjusting an optical pickup comprising:
a first signal recording part that is irradiated with a laser beam from one surface side; and
a second signal recording part that is irradiated with the laser beam from the other surface side to record data so that a scanning direction by the laser beam is opposite to that of the first signal recording part.

2. The optical disc for adjusting an optical pickup according to claim 1, wherein a recording area provided in the first signal recording part and a recording area provided in the second signal recording part are provided at radial positions of the same distance from the center of the disc.

3. The optical disc for adjusting an optical pickup according to claim 1, wherein the recording area provided in the first signal recording part and the recording area provided in the second signal recording part are provided at radial positions having different distances from each other from the center of the disc.

4. The optical disc for adjusting an optical pickup according to claim 1, wherein in the first signal recording part, data is recorded so as to form a first spiral recording track, and in the second signal recording part, data is recorded so as to form a second recording track of a spiral shape in a direction opposite to that of the first recording track.

5. The optical disc for adjusting an optical pickup according to claim 1, wherein the first recording track is formed from one side of the inner peripheral side or the outer peripheral side of the disc to the other side, and the second recording track is formed from the other side of the inner peripheral side or the outer peripheral side of the disc to one side.

6. The optical disc for adjusting an optical pickup according to claim 1, wherein in the first signal recording part, data is recorded so as to form a first concentric circular recording track, and in the second signal recording part, data is recorded so as to form a second concentric circular recording track in opposite order to that of the first recording track.

7. An adjusting method for an optical pickup comprising the steps of:
mounting and rotating an optical disc for adjusting the optical pickup including: a first signal recording part that is irradiated with a laser beam from one surface side; and a second signal recording part that is irradiated with the laser beam from the other surface side to record data so that a scanning direction by the laser beam is opposite to that of the first signal recording part;
then applying the laser beam to the signal recording part of the opposed side of the first and second signal recording parts of the adjusting optical disc from at least one of the first and second optical pickups respectively disposed to be opposed to the surfaces of the adjusting disc; and
detecting a reflected light from the opposed signal recording part to adjust the one optical pickup.

8. The adjusting method for an optical pickup according to claim 7, wherein in the method, an optical axis of a photodetector of one optical pickup is coarsely adjusted under an inoperative state of the focusing control and the tracking control of an objective lens of the one optical pickup.

9. The adjusting method for an optical pickup according to claim 8, wherein in the method, the focusing control is operative and the tracking control is inoperative, and the light source of the one optical pickup is moved to coarsely adjust an optical path from the light emitting point of the laser beam to the adjusting disc.

10. The adjusting method for an optical pickup according to claim 9, wherein in the method, while the focusing control and the tracking control are operative, the reflected light from the opposed signal recording part is detected to finely adjust the optical axis of the photodetector of the one optical pickup.

11. The adjusting method for an optical pickup according to claim 10, wherein in the method, the focusing control and the tracking control are operative, and the light source of the one optical pickup is moved to finely adjust the optical path from the light emitting point of the laser beam to the adjusting disc.

12. The adjusting method for an optical pickup according to claim 11, wherein in the method, the inclination of the optical axis from the objective lens of the one optical pickup is adjusted so that a jitter component of a signal obtained from the photodetector of the one optical pickup becomes minimum.

13. The adjusting method for an optical pickup according to claim 12, wherein in the method, the output level of the light source of the one optical pickup is adjusted so that the level of a signal formed in accordance with the signal obtained from the photodetector of the one optical pickup reaches an optimum value.

14. The adjusting method for an optical pickup according to claim 7, wherein in the method, after the adjustment of one optical pickup of the first and second optical pickups is completed, the other optical pickup is adjusted.

15. The adjusting method for an optical pickup according to claim 14, wherein in the method, an optical axis of a photodetector of the other optical pickup is coarsely adjusted under an inoperative state of the focusing control and the tracking control of an objective lens of the other optical pickup.

16. The adjusting method for an optical pickup according to claim 15, wherein in the method, the focusing control is operative and the tracking control is inoperative, and the light source of the other optical pickup is moved to coarsely adjust an optical path from the light emitting point of the laser beam to the adjusting disc.

17. The adjusting method for an optical pickup according to claim 16, wherein in the method, while the focusing control and the tracking control are operative, the reflected light from the opposed signal recording part is detected to finely adjust the optical axis of the photodetector of the other optical pickup.

18. The adjusting method for an optical pickup according to claim 17, wherein in the method, the focusing control and the tracking control are operative, and the light source of the other optical pickup is moved to finely adjust the optical path from the light emitting point of the laser beam to the adjusting disc.

19. The adjusting method for an optical pickup according to claim 18, wherein in the method, the inclination of the optical axis of the objective lens of the other optical pickup is adjusted so that a jitter component of a signal obtained from the photodetector of the other optical pickup becomes minimum.

20. The adjusting method for an optical pickup according to claim 19, wherein in the method, the output level of the light source of the one optical pickup is adjusted so that the level of a signal formed in accordance with the signal obtained from the photodetector of the other optical pickup reaches an optimum value.

21. The adjusting method for an optical pickup according to claim 7, wherein in the method, the first and second optical pickups are adjusted at the same time.

22. An adjusting device for an optical pickup comprising:
a rotating and driving mechanism for rotating and driving an optical disc for adjusting an optical pickup including: a first signal recording part that is irradiated with a laser beam from one surface side; and a second signal recording part that is irradiated with the laser beam from the other surface side to record data so that a scanning direction by the laser beam is opposite to that of the first signal recording part; and
an adjusting mechanism part for applying the laser beam to the signal recording part of the opposed side of the first and second recording parts of the adjusting optical disc from at least one of first and second optical pickups respectively disposed to be opposed to the surfaces of the adjusting disc, and detecting a reflected light from the opposed signal recording part to adjust the one optical pickup.

23. The adjusting device for an optical pickup according to claim 22, further comprising a control part for controlling the operations of the first and second optical pickups, wherein the adjusting mechanism part includes a photodetector adjusting mechanism for adjusting an optical axis of a photodetector of the first or second optical pickup under an inoperative state of the focusing control and the tracking control of an objective lens of the one optical pickup by the control part.

24. The adjusting device for an optical pickup according to claim 23, wherein the adjusting mechanism part includes a light source adjusting mechanism for moving the light source of the first or the second optical pickup, while the focusing control is made operative and the tracking control is made inoperative by the control part, to adjust an optical path from the light emitting point of the laser beam to the adjusting disc.

25. The adjusting device for an optical pickup according to claim 24, wherein the adjusting mechanism part includes an objective lens adjusting mechanism part for adjusting the inclination of the optical axis of the objective lens of the first or the second optical pickup so that a jitter component of a signal obtained from the photodetector of the first or the second optical pickup becomes minimum.

26. The adjusting device for an optical pickup according to claim 25, wherein the adjusting mechanism part includes an output control part for adjusting the output level of the light source of the first or the second optical pickup so that the level of a signal formed in accordance with the signal obtained from the photodetector of the first or the second optical pickup reaches an optimum value.
